(19) United States
(12) Patent Application Publication
(10) Pub. No.: US 2009/0149981 A1
(43) Pub. Date: Jun. 11, 2009

(54) SYSTEM AND METHODS FOR CONTINUOUS, ONLINE MONITORING OF A CHEMICAL PLANT OR REFINERY

(76) Inventors: Wayne Errol EVANS, Richmond, TX (US); Derrick J. KOZUB, Houston, TX (US); Eugene Harry THEOBALD, Richmond, TX (US); Gary James WELLS, Houston, TX (US); Gerald Lynn WISE, Katy, TX (US)

Correspondence Address: SHELL OIL COMPANY, P O BOX 2463, HOUSTON, TX, 772522463, US

(21) Appl. No.: 12/190,467

(22) Filed: Aug. 12, 2008

Related U.S. Application Data
(60) Provisional application No. 60/955,727, filed on Aug. 14, 2007.

(51) Int. Cl. G06F 19/00; G06F 3/048; G06N 5/02; G06F 17/10; G06G 7/66

(52) U.S. Cl. 700/110; 715/772; 700/108; 706/46; 703/2

(57) ABSTRACT

A near real-time system and method for continuous online monitoring of a plurality of operations in a continuous chemical process facility is described. The method of monitoring the operations is based on a multivariate statistical model developed using off-line, selected process-specific historical process data. Such a model is used by an online monitoring system to monitor the continual operation of a chemical manufacturing facility or refinery in real-time from a remote location. Such real-time monitoring allows for determination of whether one or more of the plurality of operations are operating within their normal operational parameters. This real-time, continuous monitoring system can further be used to predict impending failures or trouble-spots within the continuous production process, or to minimize catastrophic process failures which may occur in a continuous chemical manufacturing process. Process variables, or “tags”, that are most likely related to predicted process failures can be identified by the model system, such that appropriate control actions can be taken to prevent an actual process failure occurrence, which can lead to costly production down times.

### REFERENCE TO PRIOR APPLICATIONS

This application claims the benefit of U.S. Provisional Application No. 60/955,727, filed on Aug. 14, 2007, which is incorporated herein by reference in its entirety.

### FIELD OF THE INVENTION

The invention provides methods for continuous, on-line monitoring of a chemical plant or a refinery and, more specifically, to near real-time systems and methods for monitoring transient operations during the continuous operation of chemical plants, refineries, and similar production facilities, in order to predict and/or prevent process failures or other detrimental occurrences.

### DESCRIPTION OF RELATED ART

Monitoring of modern chemical plants and refineries typically involves a system in which a variety of process variables are measured and recorded. Such systems often produce massive quantities of data, out of which only a relatively small portion is actually tracked and used to detect abnormal conditions in the plant which can lead to hazardous or otherwise undesirable results. Such abnormal conditions may be detected earlier if more use can be made of the information gathered on various process variables.

Process monitoring is an area that has become of increasing interest as manufacturers strive to simultaneously improve quality, increase production and reduce costs. Such monitoring usually involves discrete and isolated elements of an operation or plant. Multivariate statistical analysis methods, when applied as described herein, are capable of handling the large amounts of data gathered from all the relevant processes within the overall manufacturing plant.

Manufacturing industries outside of the chemical production industry, such as the steel, wood products, and pulp/paper industries have begun to apply such multivariate statistical analysis methods to large amounts of data gathered in the relevant processes. An example of such was described in U.S. Pat. No. 6,564,119, in which multivariate statistical monitoring, in particular Principal Component Analysis (PCA) was used in a section of a steel-making plant to monitor the casting process for abnormalities that could lead to a rupture in a solidified steel shell after forming. Another example of on-line monitoring can be found in U.S. Pat. No. 6,607,577 B2. In this case, a multivariate statistical model was used to determine reagent usage in a hot metal desulfurization process. The system was implemented on a computer, and uses an adaptive Projection to Latent Structures (PLS) model to estimate the amount of desulfurization reagent required to meet a targeted sulfur concentration.

The use of multivariate statistical process control (SPC) monitoring technology for batch process monitoring and fault diagnosis has also been described in both the patent and journal literature. MacGregor and co-workers [Chemometrics Intell. Lab. Systems, Vol. 51 (1); pp. 125-137 (2000)] proposed a new methodology for analyzing batch and semi-batch process variable trajectories for process development and optimization using multivariate SPC technology and a multi-block PLS algorithm. U.S. Pat. No. 6,885,907 B1 to Zhang et al. describes a near real-time system and method for online monitoring of transient operation in a continuous steel casting process. Numerous other references have suggested a number of statistical algorithms and approaches to the monitoring of a particular process within an industrial production facility.

While particular statistical analysis methods related to process data have been applied to individual processes within a plant or refinery using batch process monitoring, barriers to the development and successful use of multivariate statistical methods have prevented their implementation in an entire chemical manufacturing plant or refinery in a continuous manner. Such barriers exceed those challenges involved when only a section of a plant is monitored, as various types of upsets or imbalances can occur at numerous locations throughout a plant, making identification and location of the problem very difficult when little or no data is available to be used in statistical analysis. Thus, there exists a need for methods for monitoring integrated processes of a substantially entire portion of a chemical plant or a refinery, continuously and in near real-time. Additionally, there is a need for a continuous, on-line monitoring system that is integrated between unit operations within the plant from start to finish.

### SUMMARY OF THE INVENTION

Generally speaking, continuous, near real-time systems and methods for monitoring chemical production plants or chemical manufacturing processes, such as ethylene oxide/ethylene glycol production, and predicting problems during the manufacturing processes in real time or near real-time are described.

In one aspect of the present invention, a method for continuous, near real-time monitoring of operations in a chemical production facility is described, the method comprising the steps of retrieving historical process data of a plurality of selected process variables, developing a multivariate statistical model using PLS analysis of process variables, determining monitoring limits for the model, validating the model, and implementing the model online for continuous monitoring, wherein the model links all of the shared processes within the production process.

### DESCRIPTION OF THE FIGURES

The following figures form part of the present specification and are included to further demonstrate certain aspects of the present invention. The invention may be better understood by reference to one or more of these figures in combination with the detailed description of specific embodiments presented herein.

FIG. 1 illustrates a schematic diagram of the overall system of the present invention.

FIG. 2 illustrates a block diagram of a process for model building, implementation and on-line monitoring applied to monitoring operations in a continually or near-continually operating industrial process, in accordance with an aspect of the present invention.

FIG. 3 illustrates a flow chart outlining the steps applied to selected historical data in the model building and development module of the present invention.

FIG. 4 is a schematic illustrating the basic components of an on-line system, in accordance with an aspect of the present invention.

FIG. 5 is a schematic diagram illustrating the architecture and flow of process information in accordance with an aspect of the present invention.

FIG. 6 illustrates a view of a typical overview display map of an industrial production facility, operating in accordance with methods of the present invention.

FIG. 7 illustrates an exemplary multivariate overview screen for an individual plant section.

FIGS. 8A-8C illustrate multivariate statistical process control (MSPC) plots, range contribution selection options, and relative contribution selection options for the X-consistency (XCon or SPEx) data shown in FIG. 7.

FIG. 9 illustrates a contribution bar plot for a time range selected on the graph of FIG. 8B, showing the contributions of each model tag.

FIG. 10 illustrates an exemplary time trend for a selected tag from the contribution bar plot of FIG. 9.

FIG. 11 is a computer network system architecture overview schematic for implementing the monitoring system of the present invention in a chemical production plant.

While the inventions disclosed herein are susceptible to various modifications and alternative forms, only a few specific embodiments have been shown by way of example in the drawings and are described in detail below. The figures and detailed descriptions of these specific embodiments are not intended to limit the breadth or scope of the inventive concepts or the appended claims in any manner. Rather, the figures and detailed written descriptions are provided to illustrate the inventive concepts to a person of ordinary skill in the art and to enable such person to make and use the inventive concepts.

### DETAILED DESCRIPTION OF THE INVENTION

One or more illustrative embodiments incorporating the invention disclosed herein are presented below. Not all features of an actual implementation are described or shown in this application for the sake of clarity. It is understood that in the development of an actual embodiment incorporating the present invention, numerous implementation-specific decisions must be made to achieve the developer's goals, such as compliance with system-related, business-related, government-related and other constraints, which vary by implementation and from time to time. While a developer's efforts might be complex and time-consuming, such efforts would be, nevertheless, a routine undertaking for those of ordinary skill in the art having benefit of this disclosure.

The present invention is a near real-time system for on-line monitoring of continuous industrial operations, such as chemical plant operations, using multi-variate statistical analysis technology such as principal component analysis (PCA), partial least squares (PLS) and associated methods and combinations thereof that model variations in both the X space and the Y space to develop such a process monitoring system. The multivariate model system described herein can share process parameters as necessary to continually monitor the entire process. The process monitoring system can be implemented by an appropriate process computer system, and is useful in predicting and preventing process problems, faults, and decreased productivity, such as unnecessary downtime of the process.

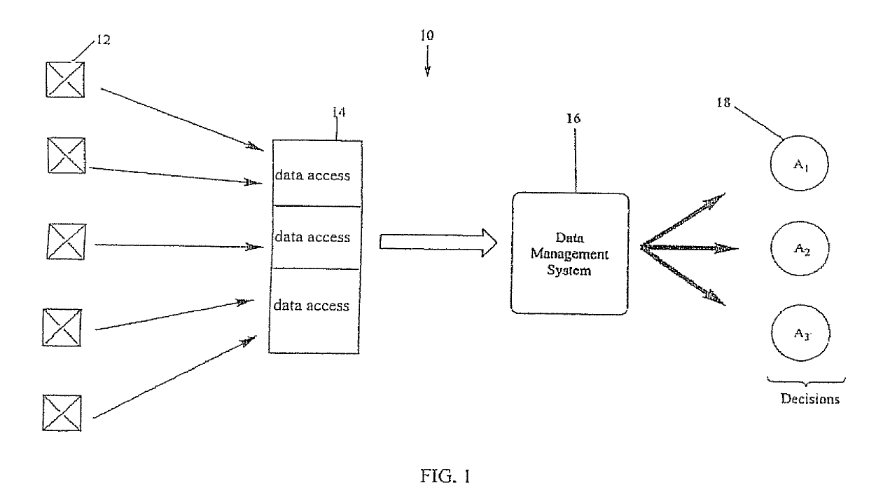

Turning now to the Figures, FIG. 1 illustrates a schematic overview of the continual, online monitoring system of the present invention. As shown therein, system 10 is comprised of a plurality of sensors, or analysis points, 12, which are conveyed to a data access or analytical station 14, such as a DCS (Distributed Control System, such as those available from Honeywell). Analysis points 12 can range from temperature and pressure data, to information obtained by monitoring bleed streams, photons, electrons, and the like during select portions of a continuously operating chemical plant, refinery, or the like. This information is then transferred, electronically or by some appropriate manual means, to a data management system 16, which includes process historians, data sinks, and the like. Data management system 16 can also comprise the multivariate statistical model for process monitoring described in detail herein. The output from the continuous, on-line monitoring of the data results in the assents and decisions, 18. More specifically, the near real-time, multivariate modeling of a continuous industrial process results in process monitoring output at a variety of human-machine interfaces (HMI), e.g., computers. The various outputs and actions, A1, A2, and A3 illustrated in FIG. 1 can include an overall process control monitor and status update, the generation of alerts (such as when a temperature falls below a certain, prescribed range), and a variety of response actions (such as adjusting a flow rate, shutting off a condenser, or manually attending to an alert).

With regard to analysis points 12 suggested above, and in accordance with further aspects of the present disclosure, additional process control and subsequent reductions in operational costs can be obtained by installing a plurality of analytical sampling ports at various, strategic locations within the production plant being monitored (such as at the beginning, middle, and/or end of a specific process or step in a manufacturing process), and connecting those ports to a central analytical station for continual, near real-time monitoring. Using existing, field-proven analytical technology, the selected analyses can be performed frequently, and the data obtained can be coupled to, and integrated with, the online monitoring systems and methods described herein. While the analytical data sampling ports can be manual sampling ports, in accordance with the present disclosure, the analysis ports would be imbedded analytical points at specific locations throughout a manufacturing process, the imbedded ports being capable of both sampling and transmitting the analytical data in an appropriate manner. Such transmittal of information may be as electrons through a wire, as photons through an optical fiber, or gas/liquid samples through one or more capillary tubes to a central analytical station. Upon reaching the analytical station, cost-effective and field-proven analytical technology may be used to derive the specific information about the process conditions or chemical compositions at the various analysis points, wherein the data may be organized, assessed, and displayed using the methods and systems described herein. Data which can be acquired in this manner includes, but is not limited to, temperature data, pressure data, UV absorption data, IR spectroscopy data, pH data, specific component data, such as aldehyde concentration data for example, trace metal data, contamination data (such as sub-ppm-level feedstock contaminants including sulfur, fluorine, acetylene, arsenic, HCl, and the like), ion data (such as sodium or silicon ion data, from absorbers), and combinations thereof. The collection of the data in historians, as described herein, allows for the building of a manufacturing process history, and simultaneously allows for the continuous, near real-time online monitoring of the processes in more detail.

An illustrative example of a suitable application for this aspect is in catalyst manufacture, which could benefit from such near real-time stream analysis and data collection, especially because catalyst manufacturing processes often include the recycling of impregnated process solutions in order to optimize yield, activity, etc. Precise co-ordination of sensitive parameters such as dopant concentration, pH, air humidity, air flow, and various process temperatures can be monitored and controlled using the methods described herein. This improved control of select parameters can lead directly to better catalyst quality, as it becomes easier to obtain a product which remains within the ranges of accepted specification.

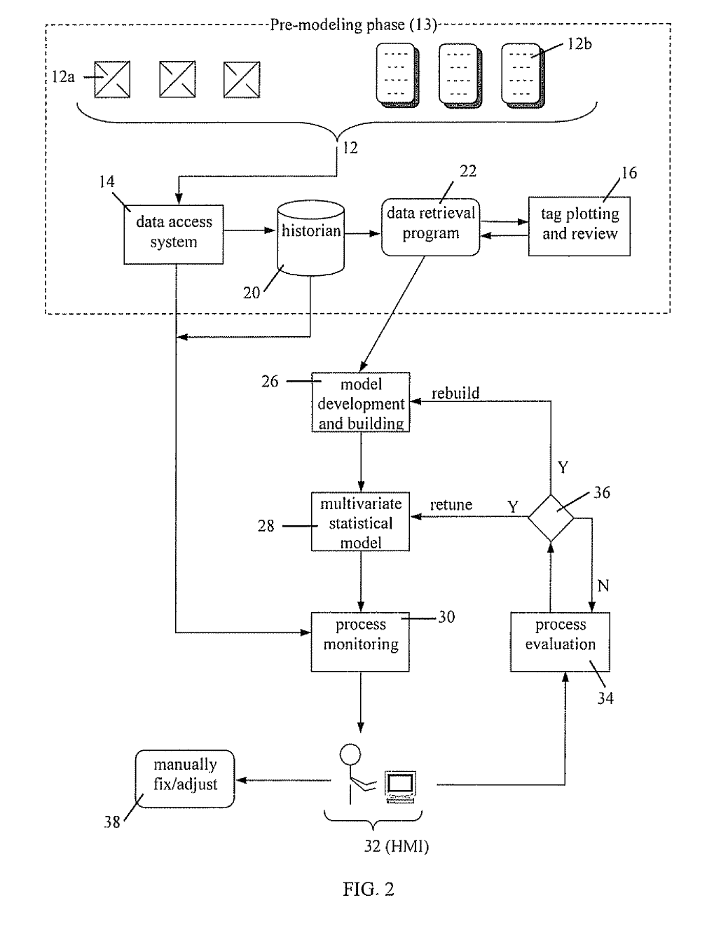

FIG. 2 illustrates a block diagram of the process for model building, implementation, and on-line monitoring for a near real-time system, as described generally in FIG. 1, and as applied to monitoring operations in a continually or near-continually operating industrial process, such as an ethylene glycol/ethylene oxide production plant. The first stage in the process, labeled collectively as the “pre-modeling” stage 13, is to decide what to monitor, and what processes and process variables will be encompassed by the model. These process variables, also known as process parameters or “tags” (12a and 12b), are selected based upon available data information, as well as an understanding of the overall continuously operating industrial process to be monitored. These tags are required in order to develop the models identified by numbers 26 and 28 in FIG. 2 and described in more detail below. Typical process variables, or “tags” 12a and 12b include but are not limited to temperature differences between processes or between two or more thermocouples, operating pressures, product flow parameters (velocity, density, etc.), coolant water flow rates, output measurements, valve sensor data, controller data, pump flow data, data related to the piping involved in the particular process (such as flow-rate and pressure of the fluid being transferred within a pipe), chemical composition data, such as reaction progress or catalyst performance, engineering and cost computation data, and the like. Tags 12a and 12b represent analytical data (12a) and data from separate sources such as notebooks, (12b) which have been captured by, or otherwise entered into, data historians 20. Data historians, as referred to herein, can gather data “tags” from the field (the production facility) and store them at a predetermined rate (e.g., every 2 minutes). Such data historians 20 typically acquire tag data on a minute basis, although the frequency of the data collection will depend largely upon the tag being monitored, and can be collected on any desirable frequency (minutes, hours, days, months, or years). Often, the measurements, or “tag data” obtained from the sensors in the production facility are collected online, in real-time or near real-time, by a data access module 14. Once the near real-time, multivariate model of the present invention has been completed, such “tag data” can be sent directly from the historian 20 or data access system 14 to an online process-monitoring module 30.

At the same time, during the pre-modeling phase 13, it must be decided how far back in time to go to capture the relevant data. Such time lengths will be process dependent, and will oftentimes be limited by, the amounts and types of data available. Typical time lengths range from about 1 year to about 5 years, although typically the “tag” data captured will be in the range of about 1 to about 2 years. At this point, all of the data from the historians 20 is obtained and processed by a data retrieval program 22, wherein a review of the tag data 16 is performed by experts in an off-line analysis, in order to remove “junk” tags—those tags not relevant to the process being modeled—and retain only the applicable data tags.

Once the first culling of “junk” tags has been performed, further iterations of the tag review 16 can proceed, wherein all of the relevant data remaining on the data historians 20 are downloaded using the data retrieval program 22, and trends of the individual variables over time are graphed for each data point. The tags are then individually evaluated to determine if the tag works or not. If the tag does not work, it is removed; otherwise, it is retained for use in building the model. Process and Instrumentation Diagrams (P&IDs) are then reviewed in a cross-referencing step, in order to ensure that the tags refer to the correct value, operation, or point within the production process. From here, the P&IDs and process tag data can be further reviewed with the engineers and/or operators at the process plant.

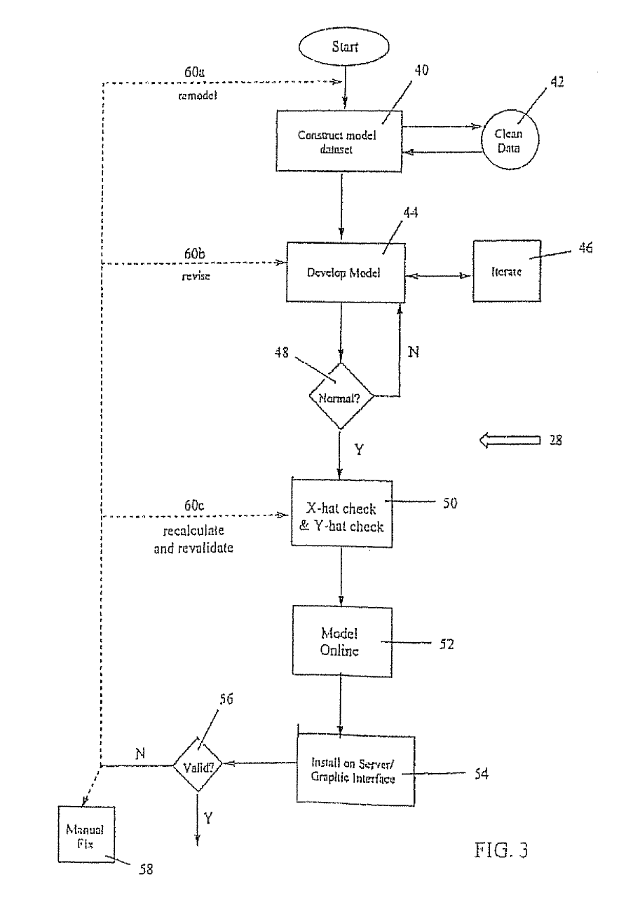

The purpose of the tag and P&ID review 16 is three-fold: to understand the logical subgroups for the development of the monitoring system, such as unit operations or manufacturing process steps; to review periods of normal operation so as to obtain “normal” value ranges for the data tags; and to identify the key monitoring objectives and response/performance variables of interest (e.g., yield, energy use, selectivity, etc.) as relates to the overall production process. With regard to the first of these, and as will be discussed in more detail below in reference to FIG. 3, while there are typically many tags per subgroup for each process section, there are also multiple, inter-related data tags that relate to parameters (such as product flow) across the “boundaries” of the “sections” within the production process, and therefore serve to connect the various sections together. In some instances, depending upon the process being modeled and its complexity, the tag and P&ID review process 16 may need to be repeated several times, as appropriate.

For a continuous chemical manufacturing process, the function block diagram of a near real-time system that is able to monitor the transient operations and simultaneously minimize errors or problems in the chemical manufacturing process is depicted in FIG. 2, although it should be noted that FIG. 2 contains both on-line and off-line steps. In addition to the process part, there are many different types of sensors 12a located throughout the entire continuous chemical manufacturing process and each sensor obtains a different measurement that represents the current operating condition of the continuous process. These measurements can include, but are not limited to, weight, temperatures, flow rate of the product through the entire process, temperatures, pressures and flow rates of inlet and outlet cooling water, compositions of outlet gases, and the like. Note that the sensors and obtained process measurements (see FIG. 1) can be different in various process designs of continuous chemical manufacturing processes, and the present invention is not limited thereto. The measurements obtained from these sensors can be collected online, in real-time, by a data access module 14, and then sent to an online process monitoring module 30. Once the process monitoring module receives the near real-time process measurements, a series of calculations are performed based on a given multivariate statistical model 28 to detect process abnormalities. The model development step 26, described in more detail in FIG. 3, is used to develop the above model offline in which the normal steady operation of a continuous chemical manufacturing process is characterized by the model from the selected process data in a process historical data repository, or data historian, 20. The process monitoring module 30 is responsible for supplying the near real-time process data, statistical metrics, and alerts concerning potential manufacturing problems and related process variables for display by a human-machine interface (HMI) 32. A performance evaluation module 34 is included in the system to monitor alerts of process problems and determine if the model needs to be re-tuned or re-built based on pre-determined model performance criteria such as false alert rate, missed alert rate, failed alert rate, and the like. If required, the multivariate statistical model can be rebuilt offline at decision point 36. The resulting model also provides certain adjustable parameters for online re-tuning to improve the model performance. For example, such adjustable parameters can be tuned online at decision point 36 to partially compensate for possible drifts from a normal change in operation region not characterized by the models, or, to exclude variables because of measurement considerations (e.g., heat exchangers are off-line to be cleaned or maintained). The excluded variables may be added back in, as appropriate, once the excluded variable has been optimized as appropriate, or brought back to normal or “near-normal”. Optionally, the problem raised by the alert in accordance with this system can be investigated by an individual within a manufacturing plant at 38, and the problem fixed or the apparatus adjusted as necessary in order to correct the problem and silence the alarm. Through the use of the present system, given the detail provided by the model 28 and the process monitoring methods, the information displayed by HMI 32 can allow the operator/engineer to specifically locate and pin-point the location within the production facility of the problem raising the alert.

FIG. 3 is a flow chart setting forth the steps in the model development module 26 (FIG. 2) of this invention to build a multivariate partial least squares (MPLS) or principal component analysis (MPCA) model from the selected historical data in order to characterize the normal operation of continuous chemical manufacturing operations. Each step is described below in detail with reference to preferred embodiments, in which the abnormal operation in particular refers to a change in one or more process parameters. There are a number of aspects to the invention that impact on its successful realization, as described below.

### Model Development

Although many abnormal data regions and “junk” tags are culled from the model building dataset during the tag review 16 (FIG. 2), an additional detailed “cleaning” of data may be required as illustrated by numeral 42 in FIG. 3. Typically, this is performed by interactions between the individuals involved directly in the process, such as the plant operators, process engineers, and the like. During the data cleaning step, several things can happen, including development of logical subgroups, establishing normal data values, and obtaining information about response variables. With regard to the first of these, developing logical subgroups for the monitoring system (i.e., for unit operations, or for specific process steps, such as those steps within an EO production process), the information is evaluated to obtain many tags per subgroup, as well as tags that cross a boundary into another process step (such as a fluid flow from one stage of the process to another stage in the process), in which case the tags are designated as tag links, thereby connecting the sections of the process together. In establishing normal data values during the data cleaning step 42, information that may be reviewed includes periods of normal operation, in order to obtain “normal”, baseline value ranges for the data tags, to determine any data spikes that should be excluded, and the like. Additionally, depending upon the process, it may be valuable to inquire and make adjustments concerning the response variables or performance variables associated with specific parts of the overall process, including, for example, yield, energy use, selectivity, catalyst selectivity, and the like. For each of these tags, during the data cleaning step 42, non-normal tag information (i.e., “noise” in the data) is excluded in order to obtain the best “normalized” data set that can reasonably be obtained, in order to develop a good model. Using the clean tags and model responses, a model set is constructed as shown in box 40, using multivariate model building such as PCA (principal component analysis), PLS (partial least squares or projections to latent structures), or any other appropriate, multivariate statistical modeling approach known in the art, including statistical process control (SPC) charts. This model dataset is then used to develop the multivariate model, step 44.

Generally speaking, the model can be developed by plotting the various behaviors of the specific processes, and defining a monitoring region within the plotted region, where new process data continues to fall within the monitoring region. A single process behavior will be described, as a general illustration. As used herein, and in accordance with conventional statistical process control (SPC) charts and processes, the information relating to each specific process can be contained in a large number of routine measurements of both the process variables (X), as well as the product quality variables (Y), otherwise known as the response variables, and corresponding to such data as yield, selectivity of compositions, etc., which is useful to assess overall performance. Typically, most of the information in the process variables that explains variations in the Y space may be captured in a small number of latent variables designated as, t₁,t₂, etc. Therefore, one can monitor the general behavior of the process by calculating the latent variable position with respect to the position and perpendicular distance on the hyper-plane and thereby define a monitoring region within the hyperspace (or plane) within which new process data (X) should continue to project as long as the process plant continues to operate normally. Such n-dimensional (n being equal to 1, 2, 3, 4, etc., as appropriate) latent variable plots are well known in the art, and typically comprise a plurality of contours to define the monitoring boundaries, corresponding to pre-determined significance levels (e.g, 1% and 5%). Under the standard assumption that latent vectors are normally distributed with zero means, these regions can often be represented as ellipses, where one or more reference distributions can be used to define the monitoring region boundaries. A similar projection plot for the product quality data Y can also then be represented using latent variables u₁, u₂ of the Y-space. New y-data, when obtained, will preferably fall within a similar region within this plane. The modeling used herein is unique in that Y is modeled as a single vector related to X allowing the monitoring of multiple y's with a single model.

Assuming that the process will continue to operate in a normal manner, then it is assumed that new observations will not only continue to project into the monitoring regions of the latent variable planes, but will also lie in or very close to the surface of these planes. Accordingly, the squared perpendicular distance of new observations (xᵢ or yᵢ) from these planes, known as the squared prediction error, or SPE, can be calculated. A general calculation for these values, SPE_{X} and SPE_{Y}, wherein X represents the process variables and Y represents the response variables, such as yield of the process or individual process step, selectivity of a process step or series of steps, and the like, may be calculated for the ith observation as:

$${SPE}_{x , i} = {\sum }_{j = 1}^{k} {( {x}_{ij} - {\hat{x}}_{ij} )}^{2} and {SPE}_{y , i} = {\sum }_{j = 1}^{m} {( {y}_{ij} - {\hat{y}}_{ij} )}^{2}$$

Wherein \hat{x}ᵢⱼ and ŷᵢⱼ are the values predicted by the multivariate statistical model. These can be plotted versus time, much as a conventional range, or s2-chart, to detect the occurrence of any new source of variation not present in the reference set. Such new sources of variation would necessarily give rise to new latent variables and therefore would result in the new observation tag data moving away from the plane defined by the original latent variables, and therefore the SPE would increase. Typically, there can be multiple y's, and so the model develops a hyperdimensional plane in Y, similar to what is done with the process variable, X. Finally, the sum of the squares of the latent variables (t²), is determined, which represents how close to the center of the area of normal variation each observation is. Using all of these parameters, the statistical model can be developed using a number of available multivariate calculation programs, including for example, SIMCA-P or SIMCA-P+ (available from Umetrics AB; Umeå, Sweden, MacStat (from McMaster University), SAS, The Unscrambler® (CAMO, Inc., Woodbridge, N.J.) and similar commercially-available programs.

Depending upon the results of the first model, the model can undergo an iteration process 46, so as to remove any new tags or data regions in time which now appear to be “junk”. Once the iteration is completed, the data is then re-fit and re-analyzed at decision prompt 48 using the multivariate statistical model in order to minimize the abnormalities in the “model set”. The iteration process can be repeated multiple times, until the desired level of abnormality minimization is achieved.

### Model Validation

Following model development, and once the updated model coefficients have been obtained, the multivariate statistical model 44 is validated through a series of checks and validations before being implemented in process step 52. This is preferably accomplished by first performing a y-hat (ŷ) check, and then performing an x-hat (\hat{x}) check on process 50. Once the model passes all of the validation checks at 50, the updated and validated model (if necessary) replaces all previous versions of the statistical model, and is ready for implementation online.

The x-hat and y-hat checks at validation step 50 are done to ensure that all individual X's and Y's are being predicted well, to improve the fidelity of the model. Additionally, such validation checks can serve to further catch any invalid data that was missed during earlier checks. Then, one may relate X to Y through T, so that good predictors are obtained, and there is a decrease, or minimization, of noise in the model. Additional checks may also be performed at validation step 50 in order to ensure that the predicted temperatures, pressures, flow rates, reagent amounts, etc. for the specific process, based on the developed model, are not significantly different from the actual values currently implemented in the specific manufacturing or production process. The x-hat and y-hat checks are used in the evaluation of potential multivariate models and/or during model refinement. The use of these checks assists in building a more robust and useful model for online implementation. The x-hat check compares individual time trends of the x variables to their predictions (\hat{x}) to determine if tags are truly multivariate in nature and are indicative of normal operation. The y-hat check compares individual time trends of the y variables to their predictions (ŷ) to determine if the particular y variable is predicted well, is operating normally, and is correlated in a normal way to the rest of the process variables. If the predicted values of the x variables do not match the measured values over certain periods of time, this may indicate an abnormal condition that should be excluded from the normal data set. Alternatively, if the particular x variable is generally not predicted well by the model over the entire time period, it may be of a univariate character and not vary with the rest of the process; in such a case, the variable may be removed from the multivariate model. When significant deviations between the measured values of the y variable and the predicted values are determined, this often indicates a deviation in the normal correlation patterns of the process that should be investigated further or excluded from the normal data set used to build the model. Both the x-hat check and the y-hat check are complementary to the examination of SPEₓ, SPE_{y}, and T², which combine information for all of the x and y variables.

With continued reference to FIG. 3, following the validation at step 50, the multivariate statistical model 44 can be configured for model implementation online (52), using methods and processes known in the art. For example, in a typical online model configuration process, coefficients are extracted from the model, using any number of specific programs available commercially or those which can be readily developed by those of skill in the art. For example, model development can be done using the program Simca-P (Umetrics AB), and a separate tool can be used for the extraction of coefficients. These extracted coefficients are then stored so that they can be retrieved by online calculations. A PLS calculation module is then configured, using, for example, the ProcessMonitor® and/or ProcessNet® (Matrikon) processing systems, in order to schedule calculations, extract data, write data out to files, and similar processes related to on-line implementation. Following this configuration, the model is installed on one or more servers/graphical interfaces (54), and implemented for use in near real-time monitoring.

During the continual operation for continuous online monitoring, the system is continuously subjected to data validation inquiries 56, especially with regard to alerts raised in accordance with the monitoring process. To that end, if the process alert raised is determined to be valid, then appropriate steps can be taken to correct the problem, such as adjusting fluid flow in a conveyance pipe, rate of reagent addition, or the like. If, however, the alert raised is determined to be false, several options can be taken. The problem can be manually fixed (58), or the multivariate statistical model itself may come under scrutiny, and as such the model itself can be remodeled (60a), revised (60b), or recalculated and re-validated (60c), as appropriate, depending upon the nature of the error.

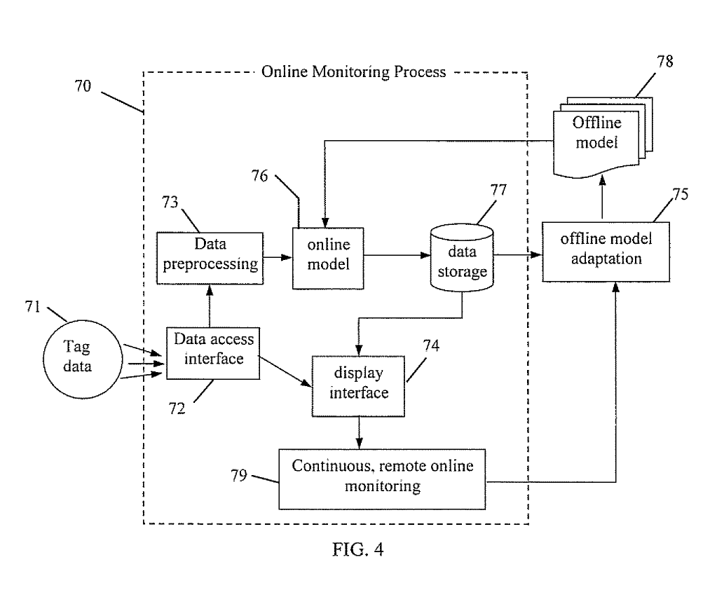

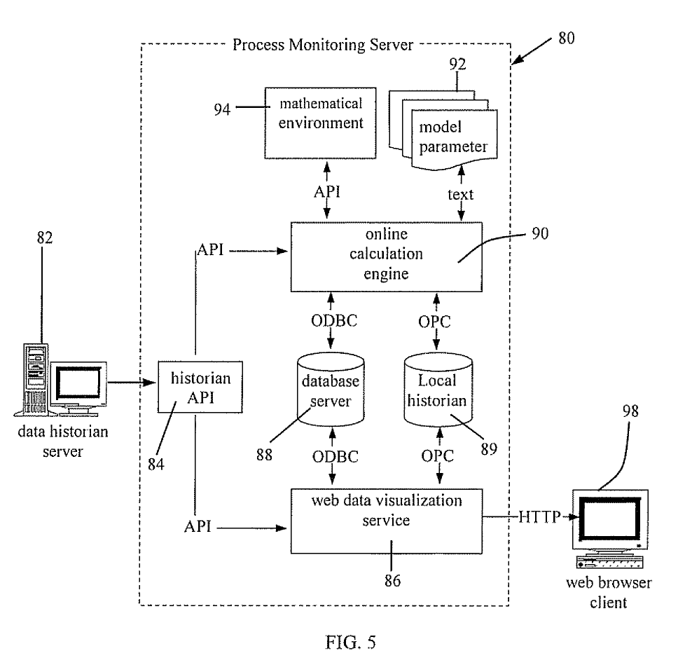

FIG. 4 displays the data flow for an example of a PLS or PCA model used to continually monitor substantially the entire manufacturing process of a particular product, e.g., a chemical product. The present invention can be used to monitor an entire plant or multiple unit operations of a plant. The system is initiated with an off-line model 78, whose development is collectively shown in FIGS. 1-3, with FIG. 2 illustrating both on-line and off-line components. The system that monitors the overall production process at each of the steps throughout the process, using the model developed as described above, is generally identified by numeral 70 in FIG. 4. The online model component 76 may typically be implemented on a computer system having access to input data 71, either through manual input or a data access interface 72 on computer network link or server, such as will be described in more detail in FIG. 5. These data values are pre-processed in step 73 to detect and replace missing or unreliable values with estimates determined as appropriate.

During operation, as shown in FIG. 4, the system continuously collects and pre-processes data from monitoring points throughout the process, and submits it to the PLS or PCA model 76 for evaluation. On an ongoing basis, model outputs are computed and written to data storage 77 for later retrieval. As illustrated by item 79, users can continuously and remotely access and review raw tag data from input source 71 as well as stored model outputs 77 (SPEx, SPEy, T², etc.). The data is provided to the user via a display interface 74, described in more detail in FIG. 5.

Typically, models require only infrequent updating during online monitoring. During the model updating step, the data stored in database 77 can be used in processing step 75, the offline model adaptation step. Additional process data is checked using the process evaluation step described in association with FIG. 2, and the new model replaces the existing online and offline models 78 and 76.

### On-Line System Use

FIG. 5 provides more detail concerning the online model implementation and data flow. Referring to FIG. 5, a schematic diagram of the detailed data flow architecture, in accordance with aspects of the present invention, is illustrated. A data historian server 82, such as the PI (Plant Information) system or similar is linked to a process monitoring server system 80 via an appropriate application program interface (API). Such API's as used and described herein are known in the art to be pre-written pieces of software which can be used to integrate two separate and/or different pieces of software. An example of such an API is the standard interface code used in a third-party web page to provide search functionality for using a major search engine (e.g., Google). Functions are specified that control the detailed interactions (e.g., data transfer, task initiation and control) between the interconnected pieces of software. As shown in FIG. 5, the historian API 84 to the historian server 82 is activated within system 80, allowing one or more paths of action to occur. For example, as shown in the Figure, the API may provide historian data access to the web visualization service application 86, which is a decision support software package, such as Matrikon ProcessNet or similar, that processes information from the statistical model 28 of FIG. 2. The information generated from the web visualization service 86 can then be transferred to a remote client/operator via a hypertext-transfer protocol (HTTP), wherein the remote client/operator is accessing the system for continual, on-line monitoring of a production process using a human-machine interface such as Internet Explorer® remote client 98.

Optionally, and equally acceptable, the historian interface 84 can (directly or indirectly) interact with calculation engine 90, which can be any appropriate near real-time calculation system, such as ProcessMonitor® (available from Matrikon in Edmonton, Canada). Such a calculation system, in the current invention, is integrated into a larger system for predicting and preventing process and/or equipment problems during a manufacturing process so as to maximize performance and availability. Configured calculation engine 90 receives and sends information via an API to a mathematical analysis system 94, such as MATLAB® (available from The MathWorks, Natick, Mass.), or other appropriate mathematical analysis programs known and available. Such mathematical analysis systems, such as MATLAB®, are often high-level language and interactive environments that enable developers to implement computationally intensive mathematical tasks faster than with traditional programming languages including but not limited to C, C++, Visual Basic, and Fortran. These interactive environments are used herein for a number of math-related processes or applications integral to the use of the continuous, on-line monitoring process, including but not limited to algorithm development, data visualization, data analysis, signal processing, and numeric computation.

As illustrated generally in FIG. 5, calculation engine 90 simultaneously receives text information from the model parameter archive 92, described before, which it uses in its prediction processes. While interacting with system 94 and archive 92, it simultaneously communicates with database management server 88, and local historian 89. The local historian 89 stores intermediate and final computations for later use and display, and can be implemented using a variety of available software packages such as the OPC (OLE (Object Linking and Embedding) for Process Control) Desktop Historian. The calculation engine communicates with the database management server and local historian using appropriate communication routes, such as Open Database Computing connections (ODBC), OPC interfaces, and the like. Server 88 is typically a database management system, such as a SQL Server, that can respond to queries from client machines formatted in the appropriate language, e.g., SQL (Structured Query Language). The local data historian 89 is included to store computations generated by the system for later retrieval by the calculation engine 90 or monitoring visualization service 86. Using the continual flow of information illustrated within server 80, the continual on-line monitoring processes of the present invention can be performed via Internet client 98 on the plant site or remotely. The continual online monitoring tools and interface enable detection and diagnosis of the root cause for poor or unexpected performance and unplanned manufacturing system downtime.

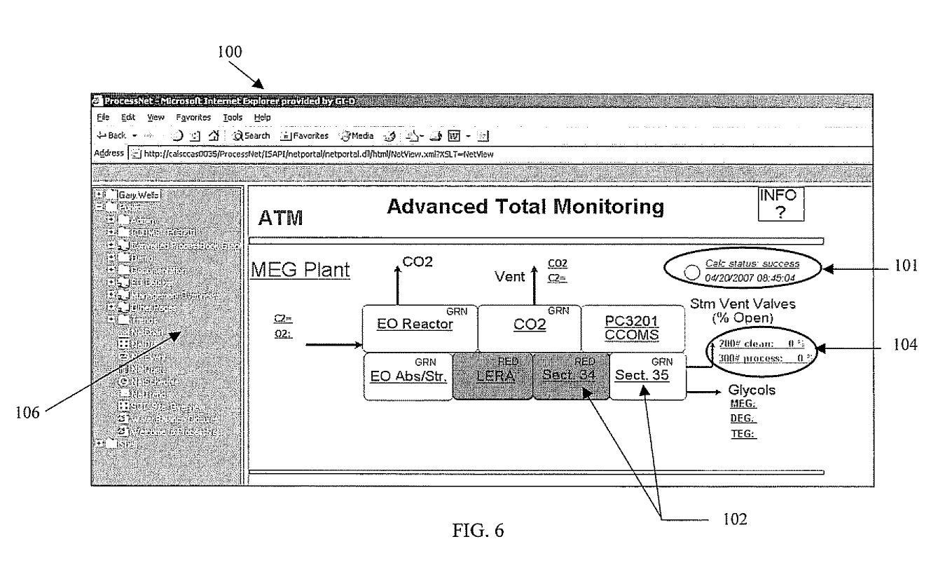

While any number of appropriate visual displays on the monitors viewed by the system operators can be used in accordance with the present invention, including electronic spreadsheets, digital dashboards, tabular data, and the like, a preferred (but in no means limiting) visual application, and the use thereof, is illustrated in FIGS. 6-9.

Referring to FIG. 6, a main overview display screen 100 of an exemplary industrial production facility during near real-time, continuous monitoring of a production process is shown, comprising a plurality of primary display elements 102 (such as EO Reactor, EO absorption and stripping, CO2 removal, light ends removal, and Quench/Glycol Bleed system, for example), also referred to as model blocks. As further illustrated in the figure, each of the primary display elements, or model blocks, 102 can have a text label or other suitable identifier associated with it, including a description of the element itself, or a symbol, graphical icon or image. For example, in the course of near real-time monitoring, a user can click their selection device, such as a mouse or other suitable computer hardware (e.g., stylus), on model block 102 to examine and investigate potential process faults related to the model block represented.

Further features of main overview display screen 100 are calculation status indicators 101, live tag data displays 104 which provide near real-time information about the process being monitored, and, optionally, a Treeview pane 106 which can allow the user to readily migrate between the trends for the process being monitored at the users discretion, using any appropriate selection device. Calculation status indicators 101 act to provide information about the calculation of the model itself, and can be prompted by moving a selection device over the appropriate section of display screen 100. Live tag data displays 104 can appear constantly on the display monitor itself as illustrated, or pop-up for display only when prompted with a selection device or menu. These live tag displays 104 can be used to display often-monitored tag data in near real-time (“live”) from the production process, including but not limited to temperature, pressure, and gas evolution data. Live tag data displays 104 may also be used to quickly evaluate the live tag data values using “drill-down” techniques, as will be described in more detail below.

The primary display elements, or model blocks, 102 can be of a plurality of colors, the colors preferably determined by a calculated, measured, or monitored attribute of the particular item or items to be monitored that is represented by the “display element” itself. The calculated, measured, or monitored attributes are directly correlated and linked to the multivariate statistical model of the present invention. While any number of colors can be used, for a variety of reasons or preferences, the display colors as typically used herein are meant to reflect a continuous, monitored range or series of values of processes being monitored. For example, the colors of the elements can correspond to the actual numerical range of one or more attributes controlling the primary display element color within the set of data that is currently being represented. Alternatively, the colors of the display elements can correspond to the possible numerical range of the attributes controlling the element color. In one aspect of the present invention, during the course of near real-time monitoring, display elements 102 can range in color from red to green, wherein green indicates stable performance of the monitored values, orange or yellow indicate potentially problematic performances, and red colored display elements indicate declining, or problematic process performance. In association with this aspect of the present invention, the continuous, on-line monitoring system is considered to include significantly all of the processes (as represented by the general model blocks 102) within the overall manufacturing process itself, allowing the manufacturing progress to be continually monitored from start to finish at user chosen time intervals, including minutely, hourly, daily, monthly, or yearly, as appropriate.

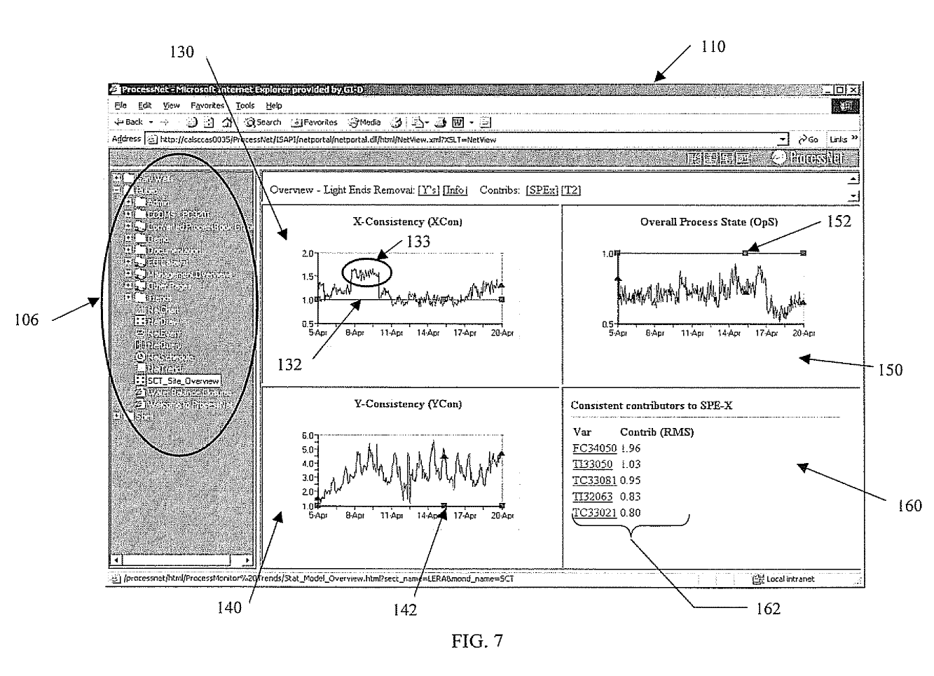

FIG. 7 illustrates a typical secondary computer overview screen display 110 with details of a general process within an industrial production facility, such as would be obtained by “drilling down” on the model blocks 102 in FIG. 6 during real-time, continuous monitoring. As used herein, “drilling down” refers to the users selecting, via an appropriate selecting means such as a mouse or through the use of a movable cursor on the display screen, a specific element or sub-element of interest, and through selecting such an element, obtaining more detailed information about the current, real-time progress of the manufacturing or process event represented by the element or sub-element. As can be seen from the figure, display screen 110 may typically comprise an optional treeview pane 106, one or more contribution or consistency plots 130, 140 and 150, as well as an optional contribution table 160, displayed in a quadrant formation as shown, although this type of display is by no means limiting, and is exemplary in nature only.

As illustrated in the model section overview screen 110 of FIG. 7, display plot 130 is an X-consistency index plot, illustrating the X-consistency (SPEₓ, also called XCon in the plots displayed here) of the specific process variable, plotted as XCon vs. time, for use in detecting the occurrence of any new source of variation not present in the reference set. Changes or variations in the process under evaluation, such as temperature of the fluid entering a reactor result in new data points moving away from the “plane” that defines the original latent variables, thereby causing an increase in XCon (SPE_{X}). As illustrated in FIG. 7, the data coming from the normal process operations in display plot 130 fall on or below the control limit 132, but as the pressure decreases (as in our present example), the SPE_{X} rapidly violates the control limit 132 in the circled region 133, indicating to the user that an event that bears further investigation has occurred. The control limits for the SPE correspond to a hypothesis test set based on the model developed and described herein, using reference data from data historians and the like. Similarly, display plot 140 illustrates the Y-consistency (YCon or SPE_{y}) associated with the process represented by the same model block 102, wherein data operations that cause the SPE_{Y} to violate control limit 142 also indicate the occurrence of an event that bears further investigation, and that has likely caused the indicating color change on display 100 in FIG. 6. Display plot 150 in FIG. 7 illustrates the overall process state (OpS or T²), and represents the distance from the center of the “normal data” of a specific process. As described in conjunction with display plots 130 and 140 above, operational data from the process that causes the value of T-squared (T²) to violate the pre-set monitoring limit 152 can indicate or suggest the occurrence of an event that the system operator or a user should further investigate.

Display quadrant 160 in FIG. 7 illustrates an optionally displayed contribution pane, which may be any number of user-designated displays. As shown in the figure, display quadrant 160 may comprise a summary table of the top five contributors 162 to the current X inconsistency. Other diagnostic tools which may be displayed in the display quadrant 160, in association with the present disclosure, may include Treemaps for the specific section of the process under analysis, or a consensus t₁-t₂ plane for the section of the process selected, such as for a specific plant section. This latter type of data projection in the latent variable space can be useful in accordance with the systems described herein for diagnosis purposes. For example, this type of display may be useful in ascertaining faults such as impurity contamination, reactor fouling, and the like that can be characterized by the data projections moving into specific regions of the latent variable space. While not illustrated herein, a plurality of variables may be displayed, plotted on a t₂ vs. t₁ plane, wherein the monitoring region is illustrated by an oval or similar boundary line. Those data points occurring “outside” of the monitoring region may be due to any number of model variables, including possible impurities, erroneous temperatures or pressures, and the like, and therefore are points that may require further investigation, as necessary.

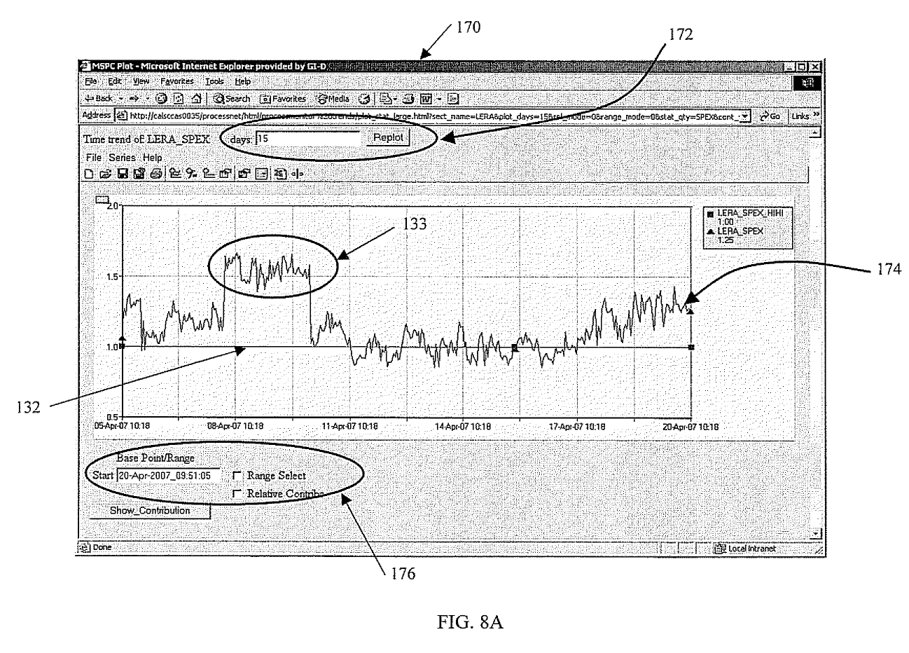

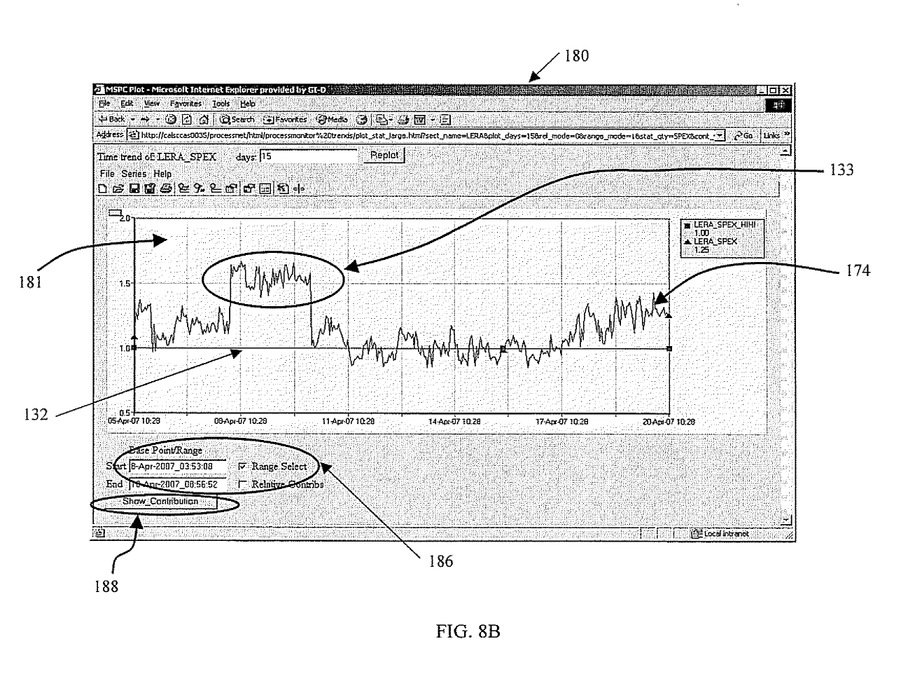

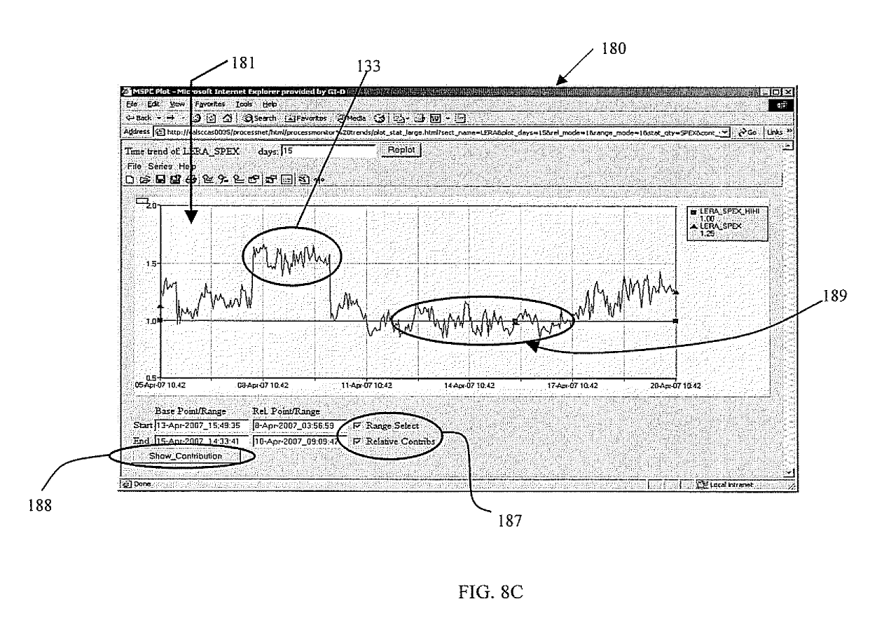

In the event that a user wants more details about a specific feature of the overall process, or desires to obtain more details as to specific or potential problems within one of the elements or sub-elements of the display, the user may obtain further detailed information by selecting a specific region of interest lying outside the control limit in one or more of the plots illustrated in FIG. 7, thereby “drilling down” to a further sublevel of information concerning the details of the process. FIG. 8A illustrates an exemplary display screen 170 with an expanded view of display plot 130 of FIG. 7, illustrating not only the time range 172 displayed, but user-selectable options 176 for computing relative and/or range contributions, and a time trend of the MSPC metric 174 that allows the user to select one or more points in time for further review of prediction errors contributing to the MSPC violation. In particular, the MSPC plot 174 illustrates the X-consistency (SPEₓ), and its difference from normal over a period of time (shown along the bottom axis) for a particular process, in this example the light ends removal (LERA) process. In this manner, it can be seen more clearly that one or more of the detected process operation data points 174 are contributing to the violation of the monitoring limit 132 for this element of the overall manufacturing or production process. In continuing our example of a sudden buffer vessel pressure drop, the MSPC plot and further drill-down information allows the user of the present continuous, on-line monitoring system to direct an engineer in the process plant where to investigate potential problems in the production process. This information is useful for specifically locating the problem point or points within a manufacturing process, thereby allowing for the process to be further streamlined, product production maximized, and safety controls to be maximized, thereby minimizing unnecessary or unwanted hazards or events.

FIG. 8B shows the display window 180. In FIG. 8B, an alternate view of the MSPC time trend 181 of the plot 174 of FIG. 8A is illustrated, wherein the user has selected a desired start and end date range at 186 for further review by “drilling down” to specific individual process points of interest that are contributing to the MSPC error. To initiate the contribution analysis, the user selects the execution button 188, in order to generate a plot of the tag contributions to the SPEₓ metric over the selected time range. The display illustrates the time-varying SPEₓ metric 174, the value of the threshold monitoring limit 132, and the circled range of outlying data points of interest 133. FIG. 8C is an illustration of requesting and obtaining the relative contribution calculations for the data points shown in FIG. 8B. As illustrated therein, both the range selection and relative contribution options at 187 have been selected, after which the start and end points for the base range 189 within display plot 181 are selected. The start and stop points for the range of interest 133 regarding relative contribution are then selected, and the button 188 is selected to execute the calculation.

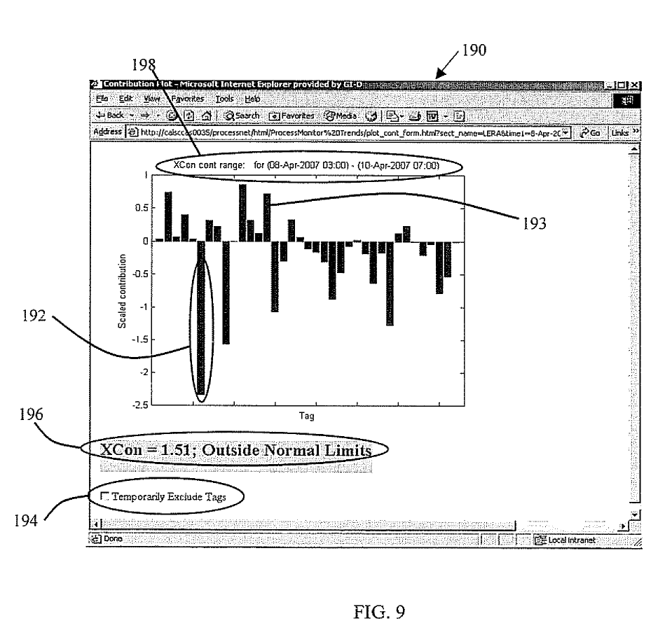

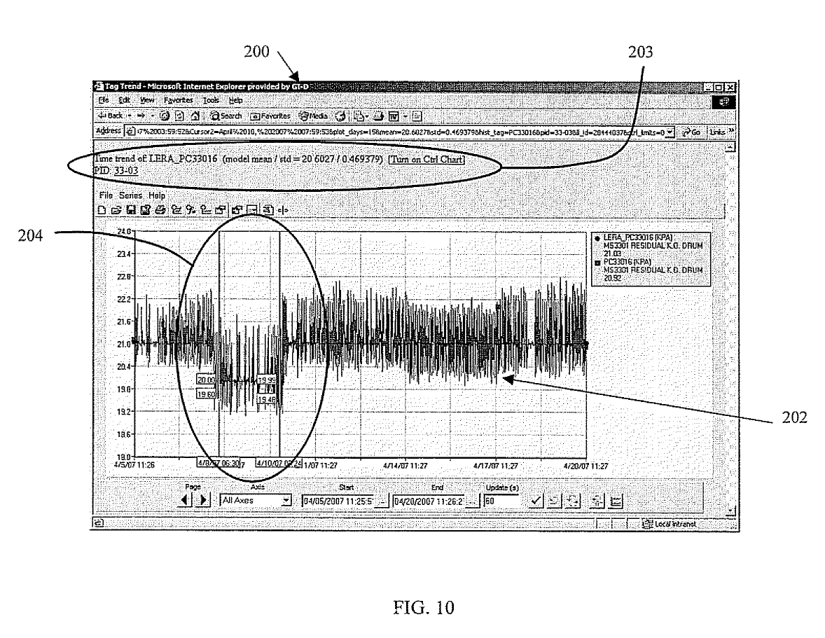

FIG. 9 shows the display window 190 illustrating the drill-down from the display plot 181, showing range contributions of the tags as a bar plot of scaled contribution versus tag. The display window illustrates both positive and negative contributing tags, 192 and 193, respectively, as well as an indicator 198 displaying the type of contribution (in this case, XCon or SPEₓ), and the time range for the displayed contributions. The display window 190 may also provide information concerning the value of the inconsistency versus the limits, as shown in display text 196. A selection device 194, such as a check box, for allowing the temporary exclusion of tags from their contribution, may also be optionally included. By placing a suitable selection device over a bar, such as 192, the user can obtain tag description information, and by selecting the desired bar, can view time trend information such as shown in FIG. 10. FIG. 10 illustrates the time trend graphic plot in display window 200, showing an exemplary tag plot 202 over time which results from the drill-down of tag 192 in FIG. 9. The display window 200 also contains an indicator 203 for displaying information relating to the plot shown. Such trends and tag plots as illustrated in FIG. 10 may be displayed using appropriate software or applications such as the NetTrend software tool (available as part of the Matrikon ProcessNet suite, Edmonton Alberta, Canada). In our current example, the time trend of a buffer vessel pressure is shown, and the circled region 204 can be seen to correspond to a potentially-abnormal, sudden drop in the pressure. In the current example, this pressure drop is the ultimate cause of the high X consistency error (SPEx) observed in the circled region 133 of FIGS. 7 through 8C and examined by “drilling down” in FIGS. 6 through 9. Thus, the user can determine within a few layers of drill-down, the appropriate process points within substantially the entire manufacturing process, where potential abnormalities have occurred.

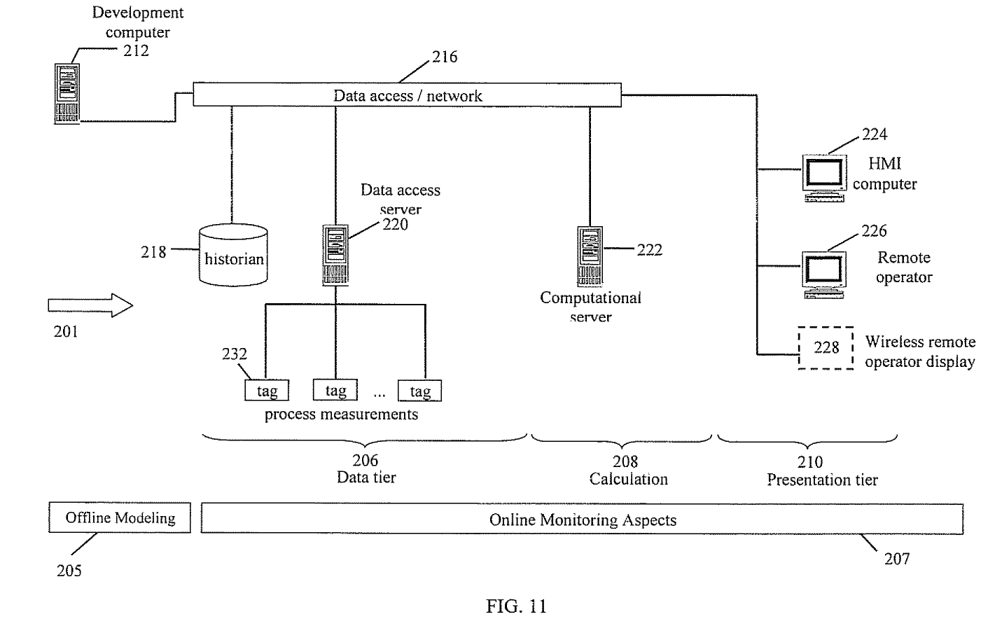

Referring now to FIG. 11, an overall computer system 201 is illustrated for an industrial implementation of a continuous online monitoring system for use in near real-time operation having integrated communications between the various unit operations for a manufacturing process. The system architecture shown in FIG. 11 can consist of two basic components: the online monitoring system 207 and the offline modeling system 205. The online monitoring system is designed following a standard three-tier software development framework, comprising a data tier 206, a calculation tier 208, and a presentation tier 210.

Within the data tier 206, the data access server 220 provides continuous, near real-time access to a plurality of process measurements (tags) 232, from multiple unit operations in the manufacturing process or facility. In accordance with some, non-limiting embodiments of this invention, OPC data access specification may be adopted, although PI may also be used as appropriate or desired. The selected near real-time data are supplied to the second tier 208 for model calculation, and at the same time to a process historical database 218 for data archiving purposes, via a data access network 216, typically implemented using an Ethernet connection. The archived data can be used by the offline modeling system as necessary, for example, when the MPLS (multivariate projection to latent structures) or MPCA (multivariate principal component analysis) models are required to be re-built or modified in light of a change in the overall production process.

Calculation Tier 208 of FIG. 11 comprises a computational server 222, capable of receiving the near real-time data via the data access interface (e.g., 216). Server 222 can perform the MPLS or MPCA calculation(s), and send any alert-related information to an HMI (human-machine interface) computer 224 or remote operator 226, 228.

Presentation Tier 210 can comprise an HMI computer 224, a remote operator display system 226 connected to the system via the Internet or a secured server, and/or a remote operator display 228 connected to the system via a wireless connection, such as a PDA, which may or may not be a dedicated device. The human-machine interface computer system 224 may be located directly in the manufacturing facility control room, and is typically able to display the current operating conditions, provide an alert regarding impending process abnormalities such as abnormal temperature spikes or flow control problems (based on the information provided by SPE and T-squared statistics from the multivariable model described herein), and support operators to make a correct decision when an alert is generated. The server-to-user interface for use with computer system 224 can be any suitable interface known in the art, including but not limited to Internet Explorer (available from Microsoft Corp.) or similar software.

The offline modeling system 205 includes one or more development computers 212 which connect to the production network via the data access network 216. The development computers 212 are able to access process historical data as described herein for use in continual MPLS or MPCA model development, model performance evaluation and other ad-hoc analysis. These analyses are very important to keep the system running with a high uptime. Additionally, while both MPLS and MPCA model development methods are applicable herein, in accordance with one aspect of the present invention, the preferred method of statistical model development is MPLS, or PLS.

One skilled in the art will realize that the aforementioned computer system may vary in different circumstances, for example, a customized data acquisition system may be used to replace the data access server, or the display function in HMI machine may be integrated into other control systems such as a Distributed Control System (DCS), and the like. Therefore, this invention is not limited to only the system or architecture illustrated above.

### INDUSTRIAL APPLICABILITY

The methods and systems described herein can be applied to a variety of manufacturing scenarios. For example, in addition to being suitable for use in the continuous online monitoring of a chemical manufacturing plant including but not limited to ethylene oxide, ethylene glycol, styrene, lower olefins, propane diol (PDO, biological or synthetic), or similar such chemical manufacturing plants, the systems and methods described herein can also be applied to refineries, petrochemical production facilities, catalyst manufacturing facilities, and the like. For example, the continuous, near real-time monitoring systems and methods of the present invention can be used in monitoring catalyst performance during a chemical process, as well in monitoring performance characteristics of machinery, such as rotating equipment. Additionally, the systems and methods described herein may be used in monitoring of remotely-located facilities, such as compressors. Other applications include the continuous, near real-time monitoring of processes, such as hydraulic fracturing, water-control, and production in multiple, remotely-located hydrocarbon or water producing wells. In general, the systems described herein may be used with nearly any chemical or manufacturing process or component thereof having at least one multivariate character.

The present invention has been described in the context of preferred and other embodiments and not every embodiment of the invention has been described. Obvious modifications and alterations to the described embodiments are available to those of ordinary skill in the art. The disclosed and undisclosed embodiments are not intended to limit or restrict the scope or applicability of the invention conceived of by the Applicants, but rather, in conformity with the patent laws, Applicants intend to protect all such modifications and improvements to the full extent that such falls within the scope or range of equivalent of the following claims.

What is claimed is:

1. A near real-time system for continuous online monitoring of operating states in an industrial production facility, the system comprising:
a plurality of analytical data measurement sensors positioned within an industrial production facility;
a multivariate statistical model; and
a human-machine interface for displaying current operating conditions and recent history;
wherein the system comprises multiple unit operations of the industrial production facility.

2. A near real-time system for continuous online monitoring of a continually-operating industrial production facility and predicting impending process abnormalities, the system comprising:
a plurality of measurement sensors for obtaining near real-time process analytical data of an industrial production facility;
a data access module;
a model calculation module; and
a human-machine interface for displaying a current operating state and desired operating ranges according to a calculated process state.

3. The near real-time system of claim 1, wherein the industrial production facility is selected from the group consisting of continuous chemical production facilities, batch chemical production facilities, petrochemical production facilities, refinery process facilities, downhole hydrocarbon or water production systems, subsystems thereof, and combinations thereof.

4. The near real-time system of claim 2, wherein the industrial production facility is selected from the group consisting of continuous chemical production facilities, batch chemical production facilities, petrochemical production facilities, refinery process facilities, downhole hydrocarbon or water production systems, subsystems thereof, and combinations thereof.

5. The near real-time system of claim 1, wherein the industrial production facility comprises an ethylene oxide/ethylene glycol plant.

6. The near real-time system of claim 2, wherein the industrial production facility comprises an ethylene oxide/ethylene glycol plant.

7. The near real-time system of claim 2, wherein the human-machine interface also displays deviations from a normal operating state.

8. The near real-time system of claim 2, wherein the model calculation module includes a multivariate statistical model.

9. The near real-time system of claim 1, wherein the plurality of measurement sensors are imbedded within the production facility at a plurality of points, and are capable of transmitting data to a data historian.

10. The near real-time system of claim 2, wherein the plurality of measurement sensors are imbedded within the production facility at a plurality of points, and are capable of transmitting data to a data historian.

11. The near real-time system of claim 1, further comprising a plurality of sampling ports for obtaining gas and/or liquid samples for analysis.

12. The near real-time system of claim 2, further comprising a plurality of sampling ports for obtaining gas and/or liquid samples for analysis.

13. The near real-time system of claim 12, wherein the gas and/or liquid samples are transmitted by capillary tube to an analyzer to obtain data which is transmitted from the analyzer to a data historian.

14. The near real-time system of claim 1, wherein the measurement sensors are selected from the group consisting of pH probes, gravitometers, gas chromatographs, pressure sensors, temperature sensors, flow meters, fluid level sensors, and spectrometers.

15. The near real-time system of claim 2, wherein the measurement sensors are selected from the group consisting of pH probes, gravitometers, gas chromatographs, pressure sensors, temperature sensors, flow meters, fluid level sensors, and spectrometers.

16. The near real-time system according to claim 2, wherein the operating state comprises pressure, temperature, composition, flow, and volume.

17. A method for near real-time monitoring the operation of a continuous or batch industrial production facility, the method comprising:
acquiring process data from multiple unit operations in an industrial production facility to be monitored;
developing a multivariate statistical model corresponding to normal operation of the industrial production facility;
validating the multivariate statistical model using an x-hat check and/or a y-hat check;
generating a continuous, near real-time on-line monitoring system incorporating the multivariate statistical model;
acquiring on-line measurements of process parameters from multiple unit operations during operation of the industrial production facility; and
determining if the on-line measurements are consistent with normal operation parameters as described by the multivariate statistical model.

18. The method of claim 17, wherein the industrial production facility is selected from the group consisting of continuous chemical production facilities, batch chemical production facilities, petrochemical production facilities, refinery process facilities, downhole hydrocarbon or water production systems, subsystems thereof, and combinations thereof.

19. The method of claim 17, wherein the industrial production facility comprises an ethylene oxide/ethylene glycol plant.
